(19) United States
(12) Patent Application Publication
(10) Pub. No.: US 2006/0088563 A1
(43) Pub. Date: Apr. 27, 2006

(54) Use of spray adjuvant to enhance the movement of pesticides through plant canopies to the target

(75) Inventor: Donald Penner, Williamston, MI (US)

Correspondence Address: Ian C. McLeod;McLeod & Moyne, P.C., 2190 Commons Parkway, Okemos, MI, 48864, US

(73) Assignee: Board of Trustees of Michigan State University, East Lansing, MI (US)

(21) Appl. No.: 10/972,624

(22) Filed: Oct. 25, 2004

(51) Int. Cl. A01N 25/00

(52) U.S. Cl. 424/405

(57) ABSTRACT

Pesticide compositions and methods of using the compositions for killing, inhibiting or repelling pests are disclosed. The pesticide compositions are admixtures of at least one pesticide and a repellent adjuvant. The retention of the pesticide compositions on the foliage of plants is reduced, so that the composition facilitates the penetration of the foliage onto the underlying target site. Preferably the composition is applied as a spray to provide spherically shaped particles which bounce off the foliage. The pesticide composition can be used to penetrate natural foliage such as tree canopies and underbrush, or to penetrate through cultivated foliage such as turfgrass and crops.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

(1) Field of the Invention

The present invention relates generally to pesticide compositions and more particularly to pesticide compositions having a repellent adjuvant so that retention of the composition on foliage of plants is reduced. The repellent adjuvant enhances the movement of the pesticide composition through plant canopies to the underlying targets.

(2) Description of the Related Art

U.S. Pat. No. 5,051,129 to Cuthbert et al. teach methods and compositions used for treating a surfaces such as masonry to make the surface water repellent. The compositions are aqueous solutions of a water soluble silane coupling agent and a C₁-C₆ alkyltrialkoxysilane or blends thereof. U.S. Pat. No. 5,073,195 to Cuthbert et al. teach a composition having the coupling agent and one or more alkyltrialkoxysilane and methods to treat surfaces such as masonry, textiles, paper and paperboard, leather products, and cellulosic materials.

U.S. Pat. No. 6,235,682 to Penner et al. teach herbicide compositions with a repellent adjuvant that is an aqueous solution of a one or more alkyltrialkoxysilanes with C₁-C₆ alkyl groups and a water soluble coupling agent, which form spherical particles when sprayed which bounce off a plant so that retention on foliage of the plant is reduced. Penner et al. teach methods for using the compositions to prevent weeds without also injuring cultivated plants such as crop plants, food plants, turfgrass, ornamental plants, and garden plants.

While the related art teach uses of silanes, there still exists a need for facilitating the movement of pesticides to soil, water or other underlying targets thereby minimizing the amount of pesticide needed to effectively treat an area.

### OBJECTS

Therefore, it is an object of the present invention to provide pesticide compositions which enhances the movement of the pesticide composition through plant canopies to the underlying target site.

It is further an object of some embodiments of the present invention to provide pesticide compositions which have a reduced retention on the foliage of plants so as to minimize pesticide residues on cultivated plants.

These and other objects will become increasingly apparent by reference to the following description.

### SUMMARY OF THE INVENTION

The present invention provides a pesticide composition for killing, inhibiting or repelling pests comprising in admixture at least one pesticide; and a repellent adjuvant for modifying surface properties of the composition so that retention of the composition on foliage of plants is reduced. Preferably, the pests are killed, inhibited or repelled when the composition is targeted to soil, water or a combination thereof.

In further embodiments of the composition the repellent adjuvant is an aqueous solution of an organosiliconate which has the formula (RSiO_{3/2})ₐ(X₂O)_{b} wherein X denotes sodium or potassium, and R is methyl, ethyl, or propyl, and the ratio of Si:X is about 1:1. In still further embodiments the organosiliconate is selected from the group consisting of sodium methyl siliconate, potassium methyl siliconate, and mixtures thereof. In still further embodiments the aqueous solution of the organosiliconate is a solution consisting essentially of 32 weight percent of the sodium methyl siliconate and 67 weight percent of water.

In further embodiments of the composition the repellent adjuvant comprises an aqueous solution of a water soluble silane coupling agent and an alkyltrialkoxysilane, the alkyltrialkoxysilane being selected from the group consisting of alkyltrialkoxysilanes with C1 to C6 alkyl groups on silicon and a blend of alkyltrialkoxysilanes each with a C1 to C6 alkyl groups on silicon. In still further embodiments the alkyltrialkoxysilane and the silane coupling agent are present in the aqueous solution in a mole ratio of from about 0.5:1.0 to about 3.0:1.0. In still further embodiments the alkyltrialkoxysilane is methyltrimethoxysilane and the water soluble silane coupling agent is N-(2-aminoethyl)-3-aminopropyltrimethoxysilane. In still further embodiments the aqueous solution consists essentially of: 35.7 weight percent of methyltrimethoxysilane, 58.2 weight percent of N-(2-aminoethyl)-3-aminopropyltrimethoxysilane, and 6.1 weight percent of water, prior to mixing with the pesticide solution.

In further embodiments of the composition the repellent adjuvant is selected from the group consisting of an aqueous solution of sodium methyl siliconate and an aqueous solution of N-(2-aminoethyl)-3-aminopropyltrimethoxysilane and methyltrimethoxysilane.

The present invention provides a method for killing, inhibiting or repelling pests in the presence of foliage on plants, the improvement comprising using as the pesticidal composition which comprises at least one pesticide; and a repellent adjuvant for modifying surface properties of the composition so that retention of the composition on foliage of plants is reduced. More preferably, the pests are killed, inhibited or repelled when the composition is applied to soil, water or a combination thereof. Still more preferably, the plants are crop plants.

The present invention provides a method for killing, inhibiting or repelling pests in the presence of foliage of crop plants including applying a pesticidal composition, the improvement comprising using as the pesticidal composition which comprises at least one pesticide; and a repellent adjuvant for modifying surface properties of the composition so that retention of the composition on foliage of plants is reduced and the pests are killed, inhibited or repelled when the composition is applied to soil, water or a combination thereof.

The present invention provides a method for reducing damage to plants by pests in soil, water or a combination thereof comprising providing a pesticidal composition comprising at least one pesticide admixed with a repellent adjuvant wherein the repellent adjuvant modifies surface properties of the composition thereby reducing retention of the composition on foliage of plants; and applying the composition to the plants wherein the composition bounces off the foliage onto the soil, water or a combination thereof, wherein the composition reduces the damage to the plants by the pest.

In further embodiments of any of the methods the repellent adjuvant is an aqueous solution of an organosiliconate which has the formula (RSiO_{3/2})ₐ(X₂O)_{b} wherein X denotes sodium or potassium, and R is methyl, ethyl, or propyl, and the ratio of Si:X is about 1:1. In still further embodiments the organosiliconate is selected from the group consisting of sodium methyl siliconate, potassium methyl siliconate, and mixtures thereof. In still further embodiments the aqueous solution of the organosiliconate is a solution consisting essentially of 32 weight percent of the sodium methyl siliconate and 67 weight percent of water. In further embodiments of any of the methods the repellent adjuvant comprises an aqueous solution of a water soluble silane coupling agent and an alkyltrialkyoxysilane, the alkyltrialkyoxysilane being selected from the group consisting of alkyltrialkoxysilanes with C1 to C6 alkyl groups on silicon and a blend of alkyltrialkoxysilanes each with a C1 to C6 alkyl groups on silicon. In still further embodiments the alkyltrialkoxysilane and the silane coupling agent are present in the aqueous solution in a mole ratio of from about 0.5:1.0 to about 3.0:1.0. In still further embodiments the alkyltrialkoxysilane is methyltrimethoxysilane and the water soluble coupling agent is N-(2-aminoethyl)-3-aminopropyltrimethoxysilane. In still further embodiments the aqueous solution consists essentially of 35.7 weight percent of methyltrimethoxysilane, 58.2 weight percent of N-(2-aminoethyl)-3-aminopropyltrimethoxysilane, and 6.1 weight percent of water.

In further embodiments of any of the methods the pests are in water. In some embodiments, the water is a lake, stream or ocean. In preferred embodiments the water is a breeding area for mosquitos. In more preferred embodiments, the pesticide is a mosquito controlling pesticide. In still further embodiments the composition is in soil. In still further embodiments the plant is a crop plant.

### BRIEF DESCRIPTION OF THE DRAWINGS

FIG. 1 is a histogram showing retention (microliters of spray retained per gram of plant dry matter) of pesticide solutions applied at low and high rates on tomato plants. LSD (0.05)=34.

FIG. 2 is a histogram showing retention (microliters of spray retained per gram of plant dry matter) of pesticide solutions applied at low and high rates on wheat plants. LSD (0.05)=8.

FIG. 3 is a histogram showing retention (microliters of spray retained per gram of plant dry matter) of pesticide solutions applied at low and high rates on cabbage plants. LSD (0.05)=24.

### DETAILED DESCRIPTION OF THE INVENTION

All patents, patent applications, government publications, government regulations, and literature references cited in this specification are hereby incorporated herein by reference in their entirety. In case of conflict, the present description, including definitions, will control.

The term “pest” used herein refers to any organism detrimental to or offending humans or human interests including, but not limited to insects, mites, ticks and other arthropods; disease agents such as fungi, protozoa, bacteria and viruses; helminths, nematodes (roundworms), cestodes (tapeworms), platyhelminths (flatworms), trematodes (flukes) and other worms; sporozoan parasites; slugs and snails; and vertebrates such as birds, rodents and other vertebrates.

The term “pesticide” used herein refers to any chemical or biological agent utilized to kill, inhibit or repel pests. Chemical pesticides include, but are not limited to organophosphate, carbamate, pyrethroid and organochlorine pesticides. Some examples of organophosphate pesticides are Acephate, Azinphos-methyl, Bensulide, Cadusafos, Chlorethoxyfos, Chlorpyrifos, Chlorpyrifos methyl, Chlorthiophos, Coumaphos, Dialiflor, Diazinon, Dichlorvos (DDVP), Dicrotophos, Dimethoate, Dioxathion, Disulfoton, Ethion, Ethoprop, Ethyl parathion, Fenamiphos, Fenitrothion, Fenthion, Fonofos, Isazophos methyl, Isofenphos, Malathion, Methamidophos, Methidathion, Methyl parathion, Mevinphos, Monocrotophos, Naled, Oxydemeton methyl, Phorate, Phosalone, Phosmet, Phosphamidon, Phostebupirim, Pirimiphos methyl, Profenofos, Propetamphos, Sulfotepp, Sulprofos, Temephos, Terbufos, Tetrachlorvinphos, Tribufos (DEF) and Trichlorfon.

The term “pesticide” used herein also encompasses biopesticides. Biopesticides include, but are not limited to microbial pesticides (having a microorganism such as a bacterium, fungus, virus or protozoan as an active ingredient) and biochemical pesticides (e.g. insect sex pheromones, juvenile hormones or juvenile hormone analogs). While some nematodes are considered pests, others can be beneficial and therefore can be used as biopesticides. Examples of beneficial nematodes include: S. carpocapsae, H. bacteriophora, S. riobravis, S. feltiae, H. megidis, and S. scapterisci. Some other examples of biopesticide active ingredients include: Aspergillus flavus strains which do not produce aflatoxin, Bacillus cereus, Bacillus licheniformis, Bacillus sphaericus, Bacillus subtilis, Bacillus thuringiensis (Bt), Bt delta-endotoxins, Beauveria bassiana, Pseudomonas chlororaphis, Pseudomonas aureofaciens, Trichoderma harzianum, Streptomyces griseoviridis, granuloviruses (GVs), nucleopolyhedroviruses (NPVs) and other baculoviruses. Additional examples of biopesticides are lepidopteran pheromones used to disrupt moth mating behavior such as (E)-11-Tetradecen-1-ol, (E)-11-Tetradecen-1-yl acetate, (E)-4-Tridecen-1-yl acetate, (E)-5-Decenol, (E)-5-Decenol acetate, (E)-8-Dodecen-1-yl acetate, (E)-9-Dodecen-1-yl acetate, (E,E)-8,10-Dodecadien-1-ol, (Z)-4-Tridecen-1-yl acetate, (Z)-8-Dodecen-1-ol, (Z)-8-Dodecen-1-yl acetate, (Z)-9-Dodecenyl acetate, (Z)-9-Tetradecen-1-ol, (Z)-11-Hexadecenal, (Z)-11-Hexadecenyl acetate, (Z)-11-Tetradecenyl acetate, (Z,E)-7,11-Hexadecadien-1-yl acetate, (Z,E)-9,12-Tetradecadienyl acetate, (Z,Z)-3,13-Octadecadien-1-yl acetate, (Z,Z)-7,11-Hexadecadien-1-yl acetate and (Z,Z)-11,13-Hexadecadienal. Some examples of mammal and bird repellents are 9,10-anthraquinone and methyl anthranilate. The term “pesticide” as used herein is limited to such categories as algicides, antimicrobials, biopesticides, biocides, disinfectants, fungicides, insecticides, miticides (acaricides), microbial pesticides, molluscicides, nematicides, ovicides, pheromones, repellents, rodenticides, and insect growth regulators.

The term “target” as used herein refers to sites underlying plant foliage which are the intended destination for the pesticide including, but not limited to natural ground surfaces such as soil, water (lakes, ponds, marshes, swamps, streams, puddles, etc.) and artificial surfaces such as pavement.

A water repellent adjuvant is used in the present invention for the purpose of bouncing a pesticide or other pesticide spray solution through a plant canopy, whether the canopy is trees, shrubs, field crops, turfgrass, or other plant foliage so more of the active pesticide ingredient will reach the soil, water, or other target site. The method facilitates the movement of the pesticide to the desired destination such as the soil surface or water. Since less pesticide is retained upon the plant canopy, the present invention decreases the costs of pesticide application by reducing the amount needed for application or increase efficacy. Some possible markets for the present invention include grub control in turfgrass and mosquito control for the prevention of the spread of malaria. In some embodiments, the compositions of the present invention facilitate the movement of insecticides and other pesticides through tree canopies to soil and water beneath the canopy for the purpose of controlling pests such as mosquitos. In other embodiments, the compositions facilitate the movement of pesticides through plant foliage such as turfgrass, for the purpose of grub control in the turf. In a preferred embodiment the water repellent adjuvant designated DC 1-6184 (Dow Corning, Midland, Mich.) is used.

The present invention provides a pesticide composition for killing, inhibiting or repelling pests comprising in admixture at least one pesticide and a repellent adjuvant for modifying the surface properties of the composition so that retention of the composition on foliage of plants is reduced. Preferably, the pests are killed, inhibited or repelled when the composition is applied to soil, water or a combination thereof. In the preferred embodiment, the repellent adjuvant comprising the composition is a silicon-based aqueous solution that when in combination with the pesticide results in modification of the spray droplets such that the adherence of the droplets on plant surfaces is reduced. The droplets bounce off the foliage of the plant to the ground or water where the pesticide then exerts its effect. One type of repellent adjuvant suitable for use in the present invention is exemplified by an aqueous solution of the organosiliconate having the formula:
(RSiO3/2)ₐ(X₂O)_{b}
wherein X denotes sodium or potassium, and R is methyl, ethyl, or propyl, and the ratio of Si:X is about 1:1. In a preferred embodiment of an adjuvant of this type, the organosiliconate is sodium methyl siliconate, potassium methyl siliconate, or a mixture thereof. In one embodiment, the aqueous solution of organosiliconate consists essentially of 32 weight percent of sodium methyl siliconate and 67 weight percent of water. A second type of repellent adjuvant suitable for use in the present invention is an aqueous solution of a water soluble silane coupling agent and an alkyltrialkoxysilane, the alkyltrialkoxysilane being selected from the group consisting of alkyltrialkoxysilanes with C1 to C6 alkyl groups on silicon and a blend of alkyltrialkoxysilanes each with a C1 to C6 alkyl groups on silicon, the alkyltrialkoxysilane and the silane coupling agent preferably being present in the aqueous solution in the mole ratio of between about 0.5:1.0 to about 3.0:1.0. In a preferred embodiment, the water soluble silane coupling agent is N-(2-aminoethyl)-3-aminopropyl-trimethoxysilane and the alkyltrialkoxysilane is methyltrimethoxysilane. In a most preferred embodiment, the methyltrimethoxysilane, the N-(2-aminoethyl)-3-aminopropyltrimethoxysilane, and the water are in an aqueous solution consisting of a weight percent ratio of 35.7:58.2:6.1 prior to mixing with the pesticide solution. Therefore, the silicon-based aqueous solution comprising the preferred embodiment of the present invention is selected from the group consisting of an aqueous solution of an alkali metal organosiliconate and an aqueous solution of a water soluble silane coupling agent and an alkyltrialkoxysilane.

The composition of the present invention can further include a second pesticide, an enhancer or an adjuvant which increases the activity or absorption of the first pesticide. For example, it has been found that some pesticides such as imidacloprid can be applied in conjunction with beneficial nematodes such as Heterorhabditis bacteriophora and Steinernema glaseri so as to work synergistically to combat white grubs in turfgrass.

The repellent adjuvant is most preferably selected from the group consisting of an aqueous solution of an alkali metal organosiliconate and an aqueous solution of a water soluble silane coupling agent and an alkyltrialkoxysilane. In a preferred embodiment, the repellent adjuvant is selected from the group consisting of an aqueous solution of methyl siliconate and an aqueous solution of N-(2-aminoethyl)-3-aminopropyltrimethoxysilane and methyltrimethoxysilane.

The amount of pesticide comprising the composition of the present invention and used in the method of the invention varies according to a number of parameters. In general, a rate of application from about five grams to four kilograms per hectare (g/ha) of pesticide is suitable. The rate of the repellent adjuvant in the composition can be from 0.25% to 1.0%, preferably at a rate of 0.5%. According to general cultivation practices, pesticides are mixed in a tank and applied using a sprayer. The practitioner will mix various combinations of pesticides in the tank. In practicing the present invention, the practitioner in addition to the mixture of pesticides in the tank will include the repellent adjuvant to make the composition of the present invention.

Cultivated plants within the meaning of the present invention include any plant cultivated for food or ornamentation with the exception of weeds. The cultivated plants to be protected in one embodiment of the present invention include crop plants of which corn, sugarcane, beans, rice, wheat, oats, sorghum, and a wide variety of vegetables such as tomatoes, cabbage and fruits such as strawberries are examples. In one embodiment, the method of the invention is performed where the crop to be protected is corn (Zea mays), sorghum (Sorghum halepense), sorghum (Sorghum bicolor), soybean (Glycine max) or dry bean (Phaseoulus vulgaris L.). Examples of other cultivated plants that can be protected by a pesticide composition according to the present invention are turfgrasses; flowering garden plants such as roses, tulips, carnations, orchids and the like; various herb plants such as parsley, sage, rosemary, and thyme; ornamental plants such as shrubs, holly, juniper, and spice plants.

Thus, the objective of the present invention is to enhance the movement of pesticides through plant canopies to the soil or water target. In other embodiments, an objective is to minimize pesticide residues on crop and other cultivated plants. The present invention can result in decreased pesticide residues on crop plants because it decreases foliar retention of the pesticide by the plant.

The present invention provides pesticide mixtures containing adjuvants which function as repellent adjuvants because they modify the surface properties of the mixtures. It is theorized that the repellent adjuvants modify the surface property of the mixture by causing an increase in the surface tension of the mixture, which results in spray droplets of increased surface tension. Because of the increased surface tension, the pesticide spray droplets are not retained by the plant foliage and essentially bounce off the foliage. The present invention is an improvement because it involves including in the pesticide spray solution, a material that modifies the surface properties of the spray solution, which results in decreased adherence of the spray droplets to the plant foliage.

Therefore, the present invention is a pesticide and water repellent composition wherein the surface properties of the composition are modified by the water repellent compound therein. Because these materials modify the surface properties of the pesticide spray solution, the spray droplets form spheres which bounce off the plant foliage. An example of an aqueous solution of an organosiliconate that modifies the surface properties of the pesticide spray composition is an aqueous solution of sodium methyl siliconate. Sodium methyl siliconate has been used as a water repellent treatment for surfaces (see U.S. Pat. No. 5,780,412 to Scarbourgh and references therein). An example of an aqueous solution that modifies the surface properties of the pesticide spray composition are an aqueous solution of N-(2-aminoethyl)-3-aminopropyltrimethoxysilane and methyltrimethoxysilane. When these compounds are mixed with an aqueous solution, they form an emulsion. Aqueous solutions consisting of water soluble silane coupling agents and alkyltrialkoxysilanes are described in U.S. Pat. Nos. 5,051,129 and 5,073,195, both to Cuthbert et al. which are hereby incorporated herein by reference to teach compositions which are suitable as repellent adjuvants in the present invention and methods for making them.

While the examples disclosed herein relate to pyrethroid and organophosphate insecticides, and in particular to AMBUSH® permethrin insecticide (FMC Corporation) and SEVIN® brand 4F carbaryl insecticide (Bayer CropScience, Research Triangle Park, N.C.) respectively, the present invention is not to be construed as being limited to pyrethroids or organophosphate insecticides, but encompasses pesticides in general. In addition to the composition of the present invention containing a pesticide and the repellent adjuvant, the present invention can further comprise activators and enhancers.

The following examples are intended to promote a further understanding of the present invention.

### EXAMPLE 1

Pesticides: AMBUSH® permethrin insecticide was applied at the recommended high rate of 25.6 ounces per acre, and the recommended low rate of 6.4 ounces per acre. SEVIN® 4F carbaryl insecticide was applied at the recommended high rate of 27 ounces per acre, and the recommended low rate of 16 ounces per acre.

Repellent Adjuvants: DC1-6184 is an aqueous solution of 35.7 weight percent N-(2-aminoethyl)-3-aminopropyltrimethoxysilane, 58.2 weight percent methyltrimethoxysilane and 6.1 weight percent water. DC-772 is a 32 weight percent sodium methyl siliconate and 67 weight percent water. DC2-1322 is a Dow Corning proprietary material. SYLGARD® 309 silicone surfactant is an organosilicone adjuvant mixture containing the active ingredient 2-(3-hydroxypropyl)heptamethyltrisiloxane ethoxylated, and acetate. All repellent adjuvants were obtained from Dow Corning Corp., Midland, Mich. All repellant adjuvants were applied at 0.5% (v/v), 20 gpa, and 25 psi.

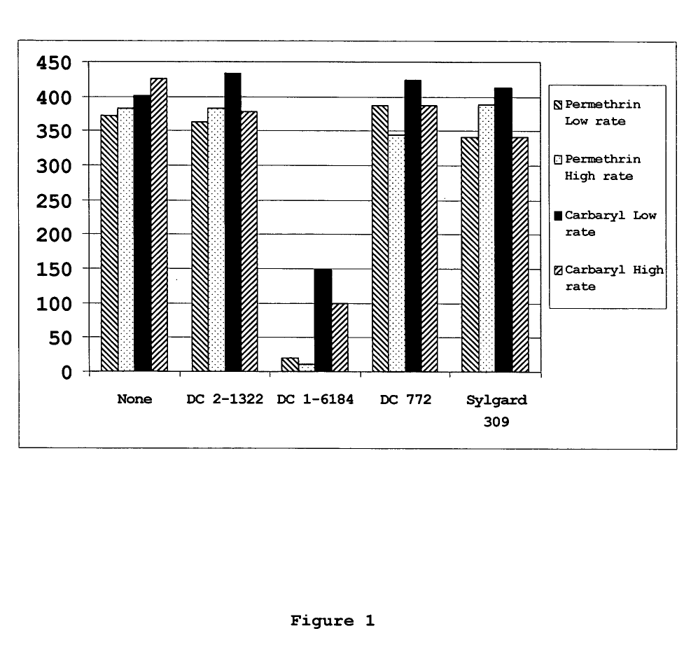

Table 1 shows the microliters (μl) of spray pesticide solution retained per gram plant dry weight on tomato, alone or with the designated repellent adjuvant or SYLGARD® 309. Table 2 shows micrograms (μg) of CHICAGO SKY BLUE dye available from Sigma Chemical Co., St. Louis, Mo.) retained per gram plant dry weight. CHICAGO SKY BLUE dye was included in the pesticide composition as a marker dye. The data in Table 1 is presented as a histogram in FIG. 1.

TABLE 1

| | | Adjuvant | | | | |
|---|---|---|---|---|---|---|
| | | | DC | DC | DC | Sylgard |
| | | None | 2-1322 | 1-6184 | 772 | 309 |
| | | μl spray solution retained per gram plant | | | | |
| Pesticide | Rate | dry weight | | | | |
| Permethrin | Low | 372 | 363 | 20 | 387 | 341 |
| | High | 383 | 382 | 11 | 345 | 389 |
| Carbaryl | Low | 401 | 433 | 149 | 424 | 414 |
| | High | 425 | 378 | 100 | 387 | 341 |

| | |
|---|---|
| LSD (0.05) | 34 |

TABLE 2

| | | Adjuvant | | | | |
|---|---|---|---|---|---|---|
| | | | DC | DC | | Sylgard |
| | | None | 2-1322 | 1-6184 | DC 772 | 309 |
| | | μg Chicago Sky Blue retained per gram | | | | |
| Pesticide | Rate | plant dry weight | | | | |
| Permethrin | Low | 928 | 907 | 51 | 968 | 853 |
| | High | 960 | 956 | 27 | 862 | 972 |
| Carbaryl | Low | 1003 | 1082 | 374 | 1060 | 1036 |
| | High | 1063 | 945 | 249 | 1066 | 993 |

| | |
|---|---|
| LSD (0.05) | 85 |

### EXAMPLE 2

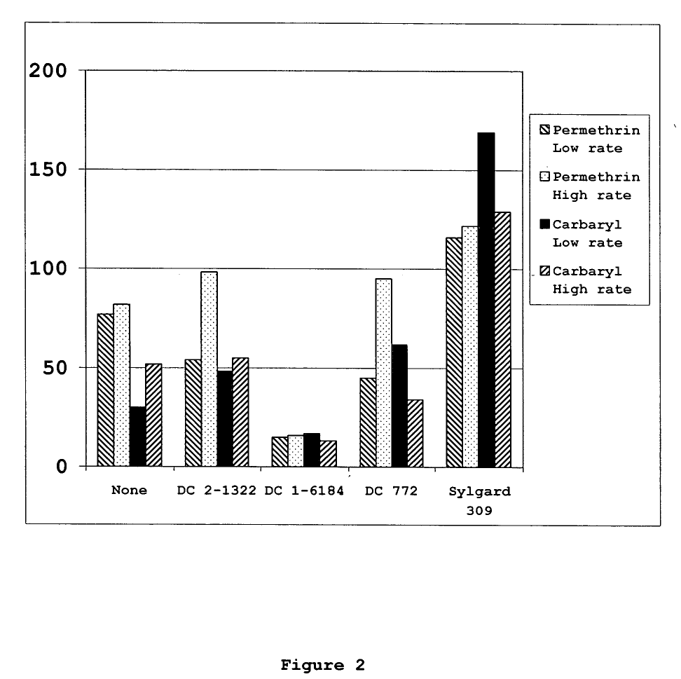

The pesticides AMBUSH® permethrin insecticide and SEVIN® brand 4F carbaryl insecticide were applied with or without repellent adjuvants as described in Example 1. Table 3 shows microliters (μl) spray pesticide solution retained per gram plant dry weight on wheat, alone or with a repellent adjuvant or SYLGARD® 309. Table 2 shows micrograms (μg) of CHICAGO SKY BLUE dye retained per gram plant dry weight. CHICAGO SKY BLUE dye was included in the pesticide composition as a marker dye. The data in Table 3 is presented as a histogram in FIG. 2.

TABLE 3

| | | Adjuvant | | | | |
|---|---|---|---|---|---|---|
| | | | DC | DC | | Sylgard |
| | | None | 2-1322 | 1-6184 | DC 772 | 309 |
| | | μl spray solution retained per gram plant | | | | |
| Pesticide | Rate | dry weight | | | | |
| Permethrin | Low | 77 | 54 | 15 | 45 | 116 |
| | High | 82 | 98 | 16 | 95 | 122 |
| Carbaryl | Low | 30 | 48 | 17 | 62 | 169 |
| | High | 52 | 55 | 13 | 34 | 129 |

| | |
|---|---|
| LSD (0.05) | 8 |

TABLE 4

| | | Adjuvant | | | | |
|---|---|---|---|---|---|---|
| | | | DC | DC | | Sylgard |
| | | None | 2-1322 | 1-6184 | DC 772 | 309 |
| | | μg Chicago Sky Blue retained per gram | | | | |
| Pesticide | Rate | plant dry weight | | | | |
| Permethrin | Low | 192 | 135 | 38 | 113 | 289 |
| | High | 205 | 244 | 41 | 237 | 305 |
| Carbaryl | Low | 75 | 119 | 43 | 154 | 422 |
| | High | 130 | 137 | 33 | 86 | 322 |

| | |
|---|---|
| LSD (0.05) | 19 |

### EXAMPLE 3

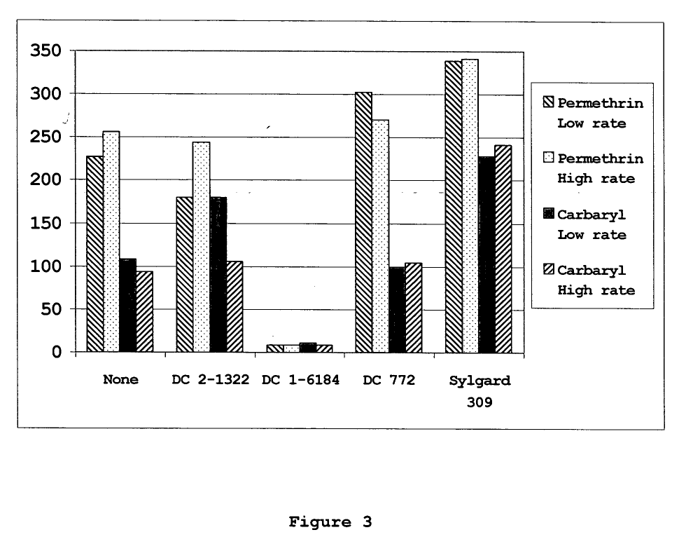

The pesticides AMBUSH® permethrin insecticide and SEVIN® brand 4F carbaryl insecticide were applied with or without repellent adjuvants as described in Example 1. Table 5 shows microliters (μl) spray pesticide solution retained per gram plant dry weight on cabbage, alone or with a repellent adjuvant or SYLGARDO 309. Table 6 shows micrograms (μg) of CHICAGO SKY BLUE dye retained per gram plant dry weight. CHICAGO SKY BLUE dye was included in the pesticide composition as a marker dye. The data in Table 5 is presented as a histogram in FIG. 3.

TABLE 5

| | | Adjuvant | | | | |
|---|---|---|---|---|---|---|
| | | | DC | DC | | Sylgard |
| | | None | 2-1322 | 1-6184 | DC 772 | 309 |
| | | μl spray solution retained per gram plant | | | | |
| Pesticide | Rate | dry weight | | | | |
| Permethrin | Low | 227 | 180 | 8 | 303 | 339 |
| | High | 257 | 244 | 8 | 271 | 342 |
| Carbaryl | Low | 108 | 180 | 11 | 100 | 228 |
| | High | 93 | 106 | 8 | 105 | 242 |

| | |
|---|---|
| LSD (0.05) | 24 |

TABLE 6

| | | Adjuvant | | | | |
|---|---|---|---|---|---|---|
| | | | DC | DC | | Sylgard |
| | | None | 2-1322 | 1-6184 | DC 772 | 309 |
| | | μg Chicago Sky Blue retained per gram | | | | |
| Pesticide | Rate | plant dry weight | | | | |
| Permethrin | Low | 569 | 450 | 21 | 758 | 849 |
| | High | 643 | 610 | 21 | 676 | 855 |
| Carbaryl | Low | 269 | 451 | 26 | 251 | 570 |
| | High | 232 | 265 | 21 | 263 | 605 |

| | |
|---|---|
| LSD (0.05) | 59 |

While the present invention is described herein with reference to illustrated embodiments, it should be understood that the invention is not limited hereto. Those having ordinary skill in the art and access to the teachings herein will recognize additional modifications and embodiments within the scope thereof. Therefore, the present invention is limited only by the Claims attached herein.

I claim:

1. A pesticide composition for killing, inhibiting or repelling pests comprising in admixture:
(a) at least one pesticide; and
(b) a repellent adjuvant for modifying surface properties of the composition so that retention of the composition on foliage of plants is reduced.

2. The composition of claim 1 wherein the repellent adjuvant is an aqueous solution of an organosiliconate which has the formula
(RSiO_{3/2})ₐ(X₂O)_{b}
wherein X denotes sodium or potassium, and R is methyl, ethyl, or propyl, and the ratio of Si:X is about 1:1.

3. The composition of claim 2 wherein the organosiliconate is selected from the group consisting of sodium methyl siliconate, potassium methyl siliconate, and mixtures thereof.

4. The composition of claim 3 wherein the aqueous solution of the organosiliconate is a solution consisting essentially of 32 weight percent of the sodium methyl siliconate and 67 weight percent of water.

5. The composition of claim 1 wherein the repellent adjuvant comprises an aqueous solution of a water soluble silane coupling agent and an alkyltrialkoxysilane, the alkyltrialkoxysilane being selected from the group consisting of alkyltrialkoxysilanes with C1 to C6 alkyl groups on silicon and a blend of alkyltrialkoxysilanes each with a C1 to C6 alkyl groups on silicon.

6. The composition of claim 5 wherein the alkyltrialkoxysilane and the silane coupling agent are present in the aqueous solution in a mole ratio of from about 0.5:1.0 to about 3.0:1.0.

7. The composition of claim 5 wherein the alkyltrialkoxysilane is methyltrimethoxysilane and the water soluble silane coupling agent is N-(2-aminoethyl)-3-aminopropyltrimethoxysilane.

8. The composition of claim 7 wherein the aqueous solution consists essentially of 35.7 weight percent of methyltrimethoxysilane, 58.2 weight percent of N-(2-aminoethyl)-3-aminopropyltrimethoxysilane, and 6.1 weight percent of water.

9. The composition of claim 1 wherein the repellent adjuvant is selected from the group consisting of an aqueous solution of sodium methyl siliconate and an aqueous solution of N-(2-aminoethyl)-3-aminopropyltrimethoxysilane and methyltrimethoxysilane.

10. In a method for killing, inhibiting or repelling pests in the presence of foliage on plants, the improvement comprising using as the pesticidal composition which comprises at least one pesticide; and a repellent adjuvant for modifying surface properties of the composition so that retention of the composition on foliage of plants is reduced.

11. In a method for killing, inhibiting or repelling pests in the presence of foliage of crop plants including applying an pesticidal composition, the improvement comprising using as the pesticidal composition which comprises at least one pesticide; and a repellent adjuvant for modifying surface properties of the composition so that retention of the composition on foliage of plants is reduced.

12. A method for reducing damage to plants by pests in soil, water or a combination thereof comprising:
(a) providing an pesticidal composition comprising at least one pesticide admixed with a repellent adjuvant wherein the repellent adjuvant modifies surface properties of the composition thereby reducing retention of the composition on foliage of plants; and
(b) applying the composition to the plants wherein the composition bounces off the foliage onto the soil, water or a combination thereof.

13. The method of any one of claims 10, 11 or 12 wherein the repellent adjuvant is an aqueous solution of an organosiliconate which has the formula
(RSiO_{3/2})ₐ(X₂O)_{b}
wherein X denotes sodium or potassium, and R is methyl, ethyl, or propyl, and the ratio of Si:X is about 1:1.

14. The method of claim 12 wherein the organosiliconate is selected from the group consisting of sodium methyl siliconate, potassium methyl siliconate, and mixtures thereof.

15. The method of claim 14 wherein the aqueous solution of the organosiliconate is a solution consisting essentially of 32 weight percent of the sodium methyl siliconate and 67 weight percent of water.

16. The method of any one of claims 10, 11 or 12 wherein the repellent adjuvant comprises an aqueous solution of a water soluble silane coupling agent and an alkyltrialkyoxysilane, the alkyltrialkyoxysilane being selected from the group consisting of alkyltrialkoxysilanes with C1 to C6 alkyl groups on silicon and a blend of alkyltrialkoxysilanes each with a C1 to C6 alkyl groups on silicon.

17. The method of claim 16 wherein the alkyltrialkoxysilane and the silane coupling agent are present in the aqueous solution in a mole ratio of from about 0.5:1.0 to about 3.0:1.0.

18. The method of claim 17 wherein the alkyltrialkoxysilane is methyltrimethoxysilane and the water soluble coupling agent is N-(2-aminoethyl)-3-aminopropyltrimethoxysilane.

19. The method of claim 18 wherein the aqueous solution consists essentially of 35.7 weight percent of methyltrimethoxysilane, 58.2 weight percent of N-(2-aminoethyl)-3-aminopropyltrimethoxysilane, and 6.1 weight percent of water.

20. The method of any one of claims 10, 11 or 12 wherein the pests are in water.

21. The method of any one of claims 10, 11 or 12 wherein the composition is in soil.

22. The method of claim 12 wherein the plant is a crop plant.
